(19) United States
(12) Patent Application Publication
(10) Pub. No.: US 2026/0200313 A1
(43) Pub. Date: Jul. 16, 2026

(54) Holding Device for an Operating Medium Container, Operating Medium Container Arrangement, Motor Vehicle Undertray Assembly, and Mounting Method for a Motor Vehicle Undertray Assembly

(71) Applicant: BAYERISCHE MOTOREN WERKE AKTIENGESELLSCHAFT, München (DE)

(72) Inventors: Rui FANG, Muenchen (DE); Andreas HUBER, Velden (DE); Torsten RECH, Groebenzell (DE); Vitali ROMANENKO, Muenchen (DE)

(21) Appl. No.: 19/137,032

(22) PCT Filed: Dec. 20, 2023
(86) PCT No.: PCT/DE2023/100984

§ 371 Date: Jun. 9, 2025

(30) Foreign Application Priority Data
Dec. 20, 2022 (DE) 10 2022 134 096.1

(51) Int. Cl. B60K 15/067; B62D 27/02; B62D 65/02

(52) U.S. Cl. CPC B60K 15/067; B62D 27/02; B62D 65/02

(57) ABSTRACT

A holding device for fastening an operating medium container to a motor vehicle component includes a first fastening element with at least one first connecting portion for connecting the first fastening element to the operating medium container, a second fastening element with at least one second connecting portion for connecting the second fastening element to the motor vehicle component, and a joining connection joining the first fastening element to the second fastening element, wherein the joined connection is configured as a predetermined break point. Moreover, the technology relates to an operating medium container arrangement with the holding device, to a motor vehicle undertray assembly, to a motor vehicle and to a method for mounting a motor vehicle undertray assembly.

### BACKGROUND AND SUMMARY

The technology disclosed here relates to a holding device for fastening an operating medium container to a motor vehicle component, to an operating medium container arrangement with the holding device, to a motor vehicle undertray assembly with the operating medium container arrangement, to a motor vehicle, and to a method for mounting a motor vehicle undertray assembly.

To store a liquid operating medium, for example a fuel, such as gasoline or diesel, in a motor vehicle, it is known to provide the motor vehicle with an operating medium container, a so-called fuel tank in the example mentioned. In known motor vehicles, in particular passenger motor vehicles, the fuel tank can be attached from below to an undertray of the motor vehicle. To secure the fuel tank, use can be made of tensioning straps which are fastened on opposite sides of the fuel tank to a body of the motor vehicle and press the fuel tank vertically upward against the body.

Document DE 10 2020 103 239 B3 discloses a fastening device of an electrical energy source used for traction of an electric vehicle. Document DE 10 2019 220 626 A1 discloses an energy store securing device for vehicles and a vehicle with an energy store securing device.

It is a preferred object of the technology disclosed here to reduce or to eliminate at least one disadvantage of a previously known solution or to propose an alternative solution. It is in particular a preferred object of the technology disclosed here to provide a holding device permitting an operating medium container to be fastened to a motor vehicle component efficiently in terms of construction space and securely. Furthermore, it is an object of the present technology to provide a corresponding operating medium container arrangement, a corresponding motor vehicle undertray assembly, a corresponding motor vehicle, and a corresponding method for mounting a motor vehicle undertray assembly. Further preferred objects may arise from the advantageous effects of the technology disclosed herein.

The object/objects may be achieved by the subject matter of the independent claim(s). The dependent claims represent preferred refinements.

According to one aspect, a holding device for fastening an operating medium container to a motor vehicle component, in particular to a motor vehicle body, is proposed here. The holding device comprises a first fastening element with at least one first connecting portion for connecting the first fastening element to the operating medium container, a second fastening element with at least one second connecting portion for connecting the second fastening element to the motor vehicle component, and a joining connection. The first fastening element is joined (fastened) to the second fastening element (preferably such that it cannot be released without being destroyed) by the joining connection. The joining connection comprises a predetermined breaking point. That is to say, the holding device is designed in such a way that, when a predetermined load is exceeded, the joining connection breaks (is separated/“fails”) (by destruction of the holding device). It is emphasized that, in the present disclosure, unless stated otherwise, the term “joining connection” refers to the joining connection between the first and second fastening element.

This makes it possible to fasten the operating medium container to the motor vehicle component/to the vehicle body efficiently in terms of construction space and nevertheless comparatively securely, in particular in a relatively crash-proof manner. In particular, the two-part configuration of the holding device can make it possible in a simple way for the operating medium container to become detached in a controlled manner from the vehicle body in the event of an accident without the container wall of the operating medium container being torn open. The holding device can itself make this possible if the first fastening element is joined very firmly to the operating medium container. In the event of an accident, the joining connection comprising the predetermined breaking point can permit a controlled detaching of the operating medium container from the vehicle body without the risk of fuel escaping. It is furthermore advantageous that the operating medium container, in particular at a joining point to the first connecting portion of the holding device, can be designed with thinner walls by virtue of the predetermined breaking point of the joining connection. Material and weight can thereby be saved. Also, tensioning straps for fastening the operating medium container to the vehicle body can be dispensed with.

The term predetermined breaking point, according to its general definition, designates a region determined by a predetermined structure, form and/or design (for example, a tapering of the material) which predictably breaks above a predetermined load. In particular, the predetermined breaking point can be designed to break in the event of a predetermined relative movement between the first connecting portion and the second connecting portion such that the first fastening element becomes detached from the second fastening element. That is to say, that region of the entire holding device which breaks first, when the first fastening element is moved in a predetermined way relative to the second fastening element, e.g. in a predetermined tension test, can be designated as the predetermined breaking point. The predetermined relative movement can comprise subjecting the first fastening element to a predetermined force relative to the second fastening element. The predetermined force can be a force which exceeds a force threshold. The force threshold here can in principle be directionally dependent. If, for example, the second fastening element is fixed to the second connecting portion (e.g. is securely clamped in a test apparatus) and the first connecting portion is pushed in the direction of the second connecting portion or pulled away therefrom, the predetermined breaking point can be that region at which the holding device breaks, while the first fastening element and the second fastening elements can otherwise remain intact (unbroken).

In the context of the present disclosure, the term “connection” should be understood as meaning a manufacturing connection (what is referred to as joining). That is to say, the terms “connecting” and “joining” may be synonyms here. Each of these connections can preferably be configured as a force fit or material bond and/or require direct contact between the connecting partners at the location of the connection. Thus, the first fastening element preferably makes direct contact with the second fastening element at the location of the joining connection. Furthermore, the first fastening element makes direct contact with the operating medium container at the first connecting portion. The second fastening element can make direct contact with the motor vehicle component (body) at the second connecting portion.

The joining connection, the connection between the first fastening element and the operating medium container (also designated below as first connection) and/or the connection between the second fastening element and the motor vehicle component (also designated below as second connection) can each be configured fixedly (immovably, free from play). Preferably, the joining connection and the connection of the first fastening element to the operating medium container cannot be released without being destroyed. In addition, it is preferred that the first fastening element is secured to the second fastening element exclusively by way of the joining connection.

In a preferred variant, the joining connection is at least partially designed as a material bond. Preferably, the joining connection can be partially or completely designed as a welded joint. The welded joint can have at least one spot weld and/or at least one weld seam or can be designed as one such spot weld/weld seam. The joining connection can be additionally reinforced by adhesive and, in combination with the welded joint, can form what is referred to as a welded and adhesive joint. If the joining connection comprises a plurality of spot welds, these can be distributed at regular intervals over a joining portion (in particular the base portion, explained in more detail below) of the first fastening element, in which the joining connection is provided. For example, at most 10 or at most 5 spot welds can be provided. The weld seam preferably comprises at least one open end. For this purpose, it can be designed, for example, as a rectilinear weld seam. If a plurality of weld seams are provided, these can run parallel to one another and/or transversely to a connecting axis between a plurality of first connecting portions.

In the second fastening element, a hole, in particular an elongated hole or slot, can be formed at the location of the joining connection. In this case, the joining connection can preferably be partially or completely formed on an inner circumferential surface of the hole. If the hole is in the form of a slot, the weld seam can preferably therefore form a (one-sided, two-sided or filling) slot weld.

Furthermore, the joining connection can be at least partially designed as a rivet connection with at least one rivet. The rivet connection forms an example of a force-fitting configuration of the joining connection. Analogously to the spot welds (connecting with a material bond), the rivets can be arranged at regular intervals and/or in edge regions of the joining portion/base portion of the first fastening element. Also analogously to the spot welds, the rivets can pass through the first and second fastening elements in the joining portion. There can be at most 5, at most 4 or at most 3 rivets.

The joining connections described above are distinguished in particular by relatively low strength. In simplified terms, these joining connections are comparatively weak, and therefore they break in a defined way in the event of a severe load, for example in the event of an accident. This opens up freedom of design in the fastening of the holding device to the operating medium container. According to the designated use, the connections between the first fastening element and the operating medium container and between the second fastening element and the motor vehicle component (body component) are more stable than the joining connection. Advantageously, the joining connection can break in the event of a severe load, for example in the event of an accident, with the first fastening element being able to remain fastened to the operating medium container in order as far as possible to avoid damage to the operating medium container.

The first fastening element and/or the second fastening element can each be designed as a sheet (metal) part. Preferably, the first fastening element is designed as an elongate, strip-shaped component with an elevation formed by the base portion. The elevation can contribute to improved corrosion resistance. If the first fastening element comprises a plurality of first connecting portions, each of the first connecting portions provided can extend away from the base portion of the first fastening element. As indicated above, the joining connection can be formed on the base portion. While the first connecting portions preferably run coplanar to one another, a main plane of the base portion (in particular in the variant with spot welds or rivets) can be formed parallel to and offset in relation to a main plane of the at least one first connecting portion. The first connecting portions can be rounded at its ends facing away from the base portion in order very simply to be able to realize high-strength welding to the operating medium container.

A supporting surface, which is formed by the at least one first connecting portion, for the operating medium container can be provided on a side opposite the second fastening element (i.e. on a side of the main plane of the first connecting portion opposite the main plane of the base portion). In the fitted position of the holding device on the motor vehicle/motor vehicle component, the supporting surface can be arranged on an upper side of the holding device. As a result, the operating medium container can advantageously remain spaced apart from the base portion in the fitted position in order, for example, to improve the corrosion resistance. The resulting step between the at least one first connecting portion and the base portion can contribute synergistically to the rigidity of the first fastening element. This effect can be reinforced by increasing the number of first connecting portions and base portions, with it being possible for a base portion (designed as an elevation) to be provided between each two adjacent first connecting portions.

When looking at the holding device perpendicular to the main planes or perpendicular to the supporting surface, the base portions can be narrower than the first connecting portions. In particular, the base portions can each be designed as strip-shaped elevations, with a longitudinal direction of the respective elevation running parallel to the main direction of extent of the respectively associated abovementioned slot. That is to say, the slots can run in particular centrally along the strip-shaped elevations. On the at least one base portion, the second fastening element can be supported on the first fastening element on the side opposite the supporting surface.

In order to be able to further increase the strength of the (first) connection between the first connecting portion and the operating medium container, it is furthermore conceivable to laterally notch the first fastening element (in particular when looking at the main surface of the at least one first connecting portion) at a transition between the at least one first connecting portion and the elevation (base portion). This can be advantageous in particular if a circumferential seam is not involved, i.e., if there is a start of the seam and an end of the seam that can each act as a notch point. The at least one first connecting portion can be tapered at a transition to the base portion. This makes it possible to fixedly weld the first fastening element to the operating medium container by a comparatively long, round weld seam (in particular as an exterior weld with a start and end). Advantageously, stress peaks are shifted away from the end of the seam by the relief notch, and the stresses are low.

The second fastening element can be designed as an angle profile with a central portion and limbs protruding in different directions from the central portion at opposite ends of the central portion (and transversely to the central portion). Preferably, the angle profile is in the form of a Z profile. The limbs can advantageously run (substantially) parallel to each other. An intermediate angle between the main plane of the central portion and the limbs can be smaller than 90° and preferably between 30° and 60. The second fastening element can therefore have a Z-shaped cross section perpendicular to the supporting surface for the operating medium container. The joining connection and the second connecting portion can be provided on different limbs. Preferably, beads reinforcing the second fastening element extend from one of the limbs to the other limb. The second connecting portion can comprise a through hole. By way of this through hole, the holding device can be tightly screwed to the motor vehicle component, preferably without play, by way of a bolt. In other words, the holding device is preferably bent in order to be able to compensate for a height difference between the holder attachment to the operating medium container (tank) and the fastening point in the vehicle.

The operating medium container arrangement proposed here is provided for a motor vehicle, in particular for the motor vehicle proposed here, and comprises the operating medium container, and a holding device which is described in detail above. The operating medium container is preferably designed as a fuel tank. The joining connection here is weaker than a first connection between the operating medium container and the holding device. The term “weaker” here, as customary in the field of joining technology, denotes a lower strength. That is to say, the joining connection which is in the form of a predetermined breaking point is less robust/less stable than the first connection. In other words, as a result of a mechanical load between the second connecting portion and the operating medium container, for example in a tension test, the yield strength of the joining connection is reached before the yield strength of the first connection. The predetermined breaking point therefore preferably breaks at a lower load than the first connection. The joining connection can be designed to be less failure-proof; conversely, a higher stress can be permitted, for example because of smaller cross sections or notch points formed in a targeted manner.

In order to achieve the higher strength of the first connection, an extent of the first connection parallel to the main plane of the base portion of the first fastening element can be greater than an extent of the joining connection parallel to this main plane. The first connection can be designed as a welded joint, i.e., the holding device can be welded to the operating medium container at the first connecting portion. In this case, a welding surface of the joining connection can be smaller than a welding surface of the first connection. In particular, at least one weld seam of the first connection can be longer than a weld seam of the joining connection. Analogously, the welding surface occupied by the weld seam of the first connection can be greater than an entire surface area occupied by the spot welds.

If the holding device is welded to the operating medium container, at least one weld seam of the first connection can be formed on a circumferential edge of the at least one first connecting portion. Furthermore, the first connecting portion can be connected to the operating medium container by way of at least one plug weld. That is to say, the one first connecting portion or a plurality of the first connecting portions can each have at least one through hole, at the inner circumferential surface of which the first fastening element is welded to the operating medium container by way of the first connection.

The motor vehicle undertray assembly proposed here has the above-described operating medium container arrangement, and the motor vehicle component. The operating medium container is fixedly connected to the motor vehicle component by way of the holding device. That is to say, both the first connection and a second connection between the motor vehicle component and the holding device are advantageously designed as fixed (in particular play-free, non-sliding) connections. By contrast to the first connection, the second connection is preferably releasable without being destroyed and/or is reproducibly reversible, for example is designed as a screw connection. Analogously to the first connection, the second connection between the motor vehicle component and the holding device is also tighter than the joining connection.

Advantageously, the holding device is arranged merely on one side of the operating medium container, without engaging (like a tensioning strap) around the operating medium container. That is to say, in the fitted position of the operating medium container, the latter can be supported with its underside on the upwardly facing supporting surface of the holding device without the holding device completely enclosing the underside of the operating medium container. When looking in a cross-sectional plane perpendicular to the supporting surface, the outer side of the operating medium container can have a depression (for example in the form of a step-shaped recess). In the fitted position of the operating medium container, the supporting surface is preferably located on the underside of the operating medium container in the region of the depression. If the motor vehicle undertray assembly furthermore has an electrical energy store, the holding device can be arranged between the operating medium container and the energy store. In order to increase the efficiency of the construction space, the electrical energy store can project into the depression. In order to increase the efficiency of the construction space, the electrical energy store can project into the depression. In this way, the holding device (when looking from below) can be concealed by the electrical energy store.

The motor vehicle proposed here can comprise the holding device, the operating medium container arrangement and/or the motor vehicle undertray assembly. In particular, the motor vehicle can be a land vehicle, watercraft or aircraft (preferably a passenger motor vehicle or a utility vehicle). In particular, the motor vehicle can be driven partially electrically (hybrid) and can have the electrical energy store as the drive battery.

For the mounting of a motor vehicle undertray assembly, which is described in detail above, a method is proposed here, which comprises the following steps which can be carried out in particular in the order below:
providing an above-described operating medium container arrangement;
mounting the operating medium container arrangement on the motor vehicle component, the operating medium container arrangement being connected to the motor vehicle component by the second connecting portion, preferably so as to be releasable without being destroyed. The providing step here can comprise the holding device being joined to the operating medium container with the first connection being formed. The second connection can be produced in the mounting step.

In other words, the technology disclosed here can relate to a holder for an operating medium container (holding device; “tank holder” for short). In vehicles with combustion engines and hybrid vehicles, the liquid drive product is stored in a tank. In the case of a geometrically complex shape of the tank, tensioning straps cannot lie all the way around against the tank. In particular, tensioning straps cannot run in direct abutment over concave geometries. The present technology makes it possible to protect the tank in the event of unfavorable loads (for example in the event of a crash) from tearing open or cracking, without increasing the tank wall thickness. The technology permits the installation of large, heavy tanks (with a large fuel volume) in unconventional tank construction spaces in which a tensioning strap suspension or direct screw connection is not possible, with a simultaneously low tank wall thickness (saving on material and weight).

A two-part tank holder is proposed which fails at the connection between the two parts in the event of too severe a load. The tightness of the tank therefore continues to be ensured. The two-part tank holder consists of an intermediate sheet and the actual holder. The intermediate sheet is fastened to the tank, and the actual holder is fastened to the body or other firmly seated components or vehicle geometries. The components are connected to one another. The intermediate sheet decouples the function of “force transmission from the tank suspension” and “tank tightness” mechanically from each other. If (e.g. in the event of a crash) the tank holder fails, the actual holder is detached from the intermediate sheet while the tank remains tight per se. By way of this design, the wall thickness of the tank does not have to be increased, and it is possible to save on weight and material.

The connections with regard to operating strength and crashes can be configured in such a way that first of all failure of the connection between the holder and intermediate sheet occurs before failure of the connection to the tank occurs. The connection of the intermediate sheet to the tank can ensure, e.g. via circumferential and long weld seams, a good distribution of load without stress peaks at the start of the seam or end of the seam.

In the case of a plug weld, the weld seam is closed and therefore naturally does not have any exposed ends. In the case of a weld along the outer edge of the intermediate sheet, a constriction is introduced into the immediate sheet for load relief of the ends of the weld seam. In this way, stress peaks can also be avoided. If required, the intermediate sheet can be fastened to the tank via an additional connection in the center, such as a weld hole.

By contrast, the connection of the actual holder to the intermediate sheet can be designed in the sense of a predetermined breaking point in such a way that stress peaks are consciously provoked as points of maximum load in the event of error. This can be realized, for example, via non-circumferential, linear connections (e.g. a slot weld with a filling, two-sided or one-sided weld seam), at the connecting ends of which stress peaks can occur. Alternatively, spot welds, rivet connections or similar punctiform joining techniques may also be used.

Furthermore, the function of the component can be further optimized via the shaping of the components. By way of folded edges and the impressing of beads, the rigidity of the tank holder or of the intermediate holder can be increased. In an embodiment made of metal, structural corrosion protection can be achieved via the above-mentioned possibilities of shaping by avoiding zero gaps or narrow gaps. In addition, water drainage holes may be introduced into cavities.

The technology disclosed here will now be explained with reference to the figures, in which schematically and not true to scale:

### BRIEF DESCRIPTION OF THE DRAWINGS

FIG. 1 shows a first variant of a holding device in an operating medium container arrangement in a perspective view, the joining connection being designed as a welded joint with a plurality of spot welds;

FIG. 2 shows the holding device from FIG. 1 in a top view;

FIG. 3 shows the holding device from FIG. 1 in a cross-sectional view;

FIG. 4 shows a second variant of a holding device in an operating medium container arrangement in a top view, the joining connection being designed as a welded joint with a plurality of slot welds;

FIG. 5 shows the holding device from FIG. 4 in a cross-sectional view;

FIG. 6 shows a third variant of a holding device in an operating medium container arrangement in a top view, the joining connection being designed as a rivet connection with a plurality of rivets;

FIG. 7 shows the holding device from FIG. 6 in a cross-sectional view;

FIG. 8 shows a fourth variant of a holding device in an operating medium container arrangement in a top view, the joining connection being designed with one-sided slot welds;

FIG. 9 shows the holding device from FIG. 8 in a cross-sectional view;

FIG. 10 shows the holding device from FIG. 8 in a perspective view looking at the underside of the operating medium container;

FIG. 11 shows a motor vehicle undertray assembly in a cross-sectional view;

FIG. 12 shows a motor vehicle with the motor vehicle undertray assembly from FIG. 11; and

FIG. 13 shows a mounting method for the motor vehicle undertray assembly from FIG. 11.

### DETAILED DESCRIPTION OF THE DRAWINGS

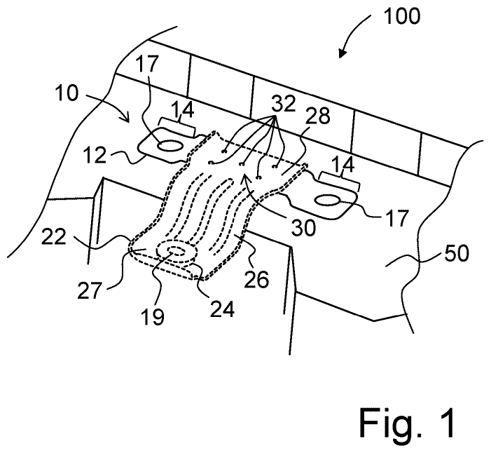

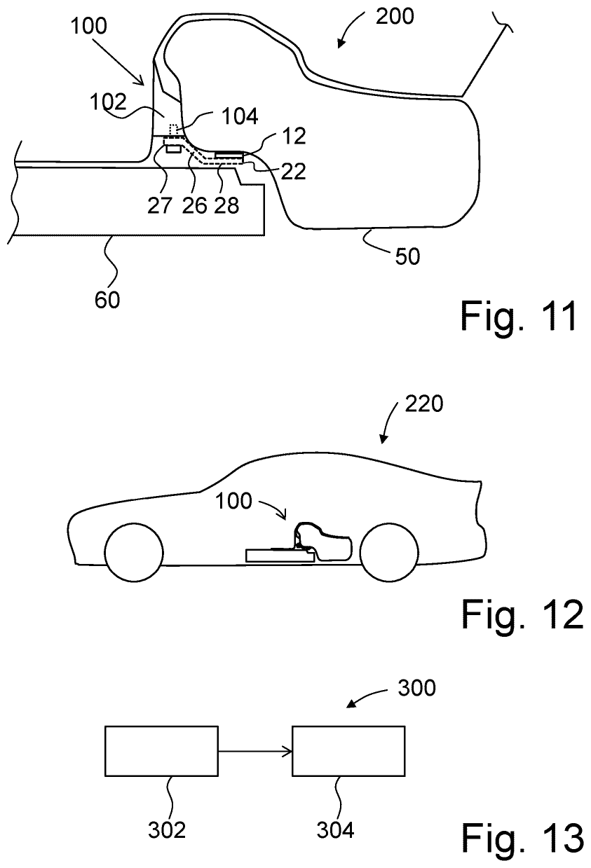

FIGS. 1 to 3 show a holding device 10 for a motor vehicle 220 which is illustrated in FIG. 12 and which here is a passenger motor vehicle. The holding device 10 (so-called holder) serves for fastening the operating medium container 50 to the motor vehicle component 102 (see FIG. 11) and accordingly together with the operating medium container 50 forms an operating medium container arrangement 100, which is illustrated in FIG. 1 in a detailed view looking from below (i.e. from the outside onto the base of the operating medium container 50). As is apparent from FIGS. 1 and 11, the operating medium container 50 in the fitted position on the motor vehicle 220 rests from above (in particular in the region of a (lateral) depression of the operating medium container 50) on a supporting surface of the holding device 10.

The holding device 10 has a first fastening element 12 and a second fastening element 22. The first and the second fastening elements 12, 22 are joined to each other/fastened to each other by a joining connection 30. Although the joining connection may be designed to be releasable without being destroyed (for example as a screw connection), it is non-releasable here without being destroyed; i.e. the first and second fastening elements 12, 22 have to be destroyed in order to be separated from each other. The first fastening element 12 comprises a plurality of first connecting portions 14 which are each joined to the operating medium container 50, preferably to the underside of the operating medium container 50, by a first connection. Each first connecting portion 14 comprises a through hole 17. An inner diameter of the respective through hole 17 can be between 8 mm and 20 mm. The respective through hole 17 can be provided for a plug weld 40 of the first connecting portion 14 to the operating medium container 50. Each plug weld 40 can comprise a first weld seam which is formed on the circumference of the through hole 17. The first weld seam preferably extends along the entire inner circumference of the through hole 17 and is therefore preferably round (“closed”). Additionally or alternatively thereto, the first connecting portion 14 can comprise a weld seam which extends along a (preferably entire) outer circumferential edge of the first connecting portion 14. A base portion 15 of the first fastening element 14 can extend from a first connecting portion 14 as far as another first connecting portion 14 and can be designed as an elevation which is spaced apart from, and runs parallel to, the supporting surface of the first fastening element 12, which supporting surface faces the operating medium container 50.

The second fastening element 22 comprises at least one second connecting portion 24 for connecting the second fastening element 22 to the motor vehicle component 102. The holding device 10 can be tightly screwed to the motor vehicle component 102 by f the second connecting portion 24 (see FIG. 11). For this purpose, in this variant, the second connecting portion 24 comprises a hole 19 with which a bolt 104 can be brought into engagement for the screw connection.

The joining connection 30 is arranged on the (at least one) base portion 15 and forms a predetermined breaking point at which the holding device 10 breaks between the first connecting portions 14 and the second connecting portion 24 when a predetermined load is exceeded. That is to say, if at least one of the first connecting portions 14 is loaded/shifted in relation to the second connecting portion 24 to such an extent that a yield strength of the joining connection 30 is exceeded, the predetermined breaking point breaks and the first fastening element 12 becomes detached from the second fastening element 22, with the first fastening element 12 remaining fixed to the operating medium container 50. Accordingly, the joining connection 30 is mechanically weaker (less strong) than the first connection between the first connecting portion 14 and the operating medium container 50. In the variant from FIG. 1, the joining connection 30 is specifically designed as a welded joint with a few, at most 5, spot welds, each spot weld having a diameter of at most 10 mm, preferably at most 8 mm, most preferably at most 5 mm.

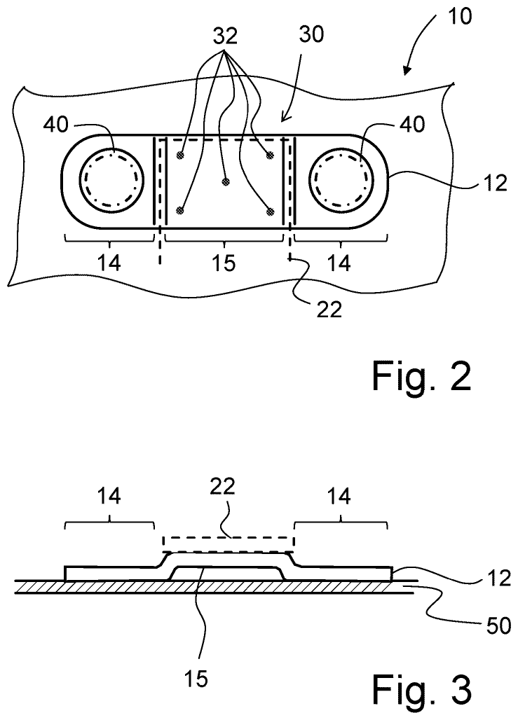

The second fastening element 22 is designed as an angle profile with a (substantially flat) central portion 26 and flat limbs 27, 28 which extend away from the central portion 26 at mutually opposite ends of the central portion. The limbs 27, 28 run here by way of example substantially parallel to each other and transversely to the central portion 26, such that the angle profile has a Z-shaped cross section. As FIG. 1 shows, the second connecting portion 24 is provided on the first limb 27 and the joining connection 30 on the second limb 28. The central portion 26 is arranged closer to the first fastening element 12 than the first limb 27. Reinforcing beads extend in the longitudinal direction of the second fastening element 22 continuously from the first limb 27 via the central portion 26 as far as the second limb 28. Additionally or alternatively to the reinforcing beads, folded edges can be provided on the second fastening element 22, in particular on the edge thereof. It can be seen from FIG. 2 that, in this variant, the second fastening element 22 merely overlaps the base portion 15, but not the first connecting portions 14, and therefore the first connection to the operating medium container 50 can be produced flexibly before or after the formation of the joining connection 30.

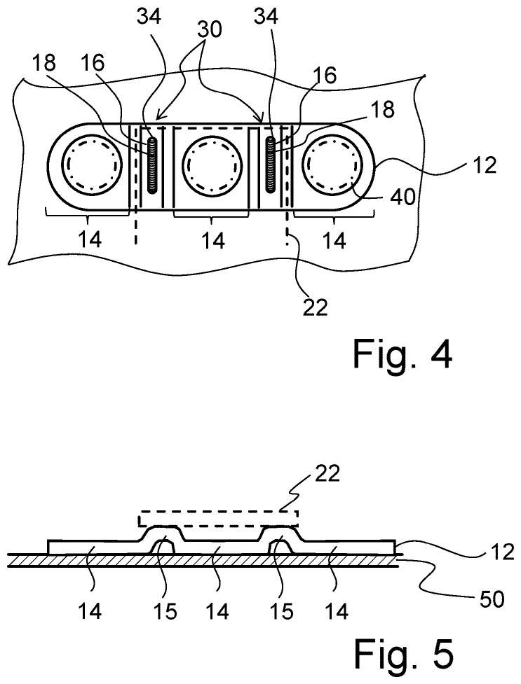

A further variant of a holding device 10 shown in FIGS. 4 and 5 differs from the holding device 10 from FIG. 1 in that the former comprises a plurality of base portions 15 which are each designed as an elevation (relative to the supporting surface) and between which a further first connecting portion 14 is formed. Analogously to the above-described connecting portions 14 of the variant from FIG. 1, this further first connecting portion 14 comprises a hole 16 in which a plug weld 40 is formed. The joining connection 30 is formed at the plurality of (the two) base portions 15. In particular, at least one hole 16 is formed in the second fastening element 22. In the variant from FIG. 4, one hole 16 is formed per base portion 15. Each of the holes 16 is slot-shaped. Accordingly, the joining connection is formed with a plurality of slot welds, with in each case one slot weld being assigned to one of the holes 16. Furthermore, the holding device 10 from FIGS. 4 and 5 comprises all of the features of the holding device 10 from FIG. 1. This applies correspondingly to the operating medium container arrangement 100. That is to say, the operating medium container arrangement 100 from FIG. 4 furthermore comprises all of the features of the operating medium container arrangement 100 from FIG. 1.

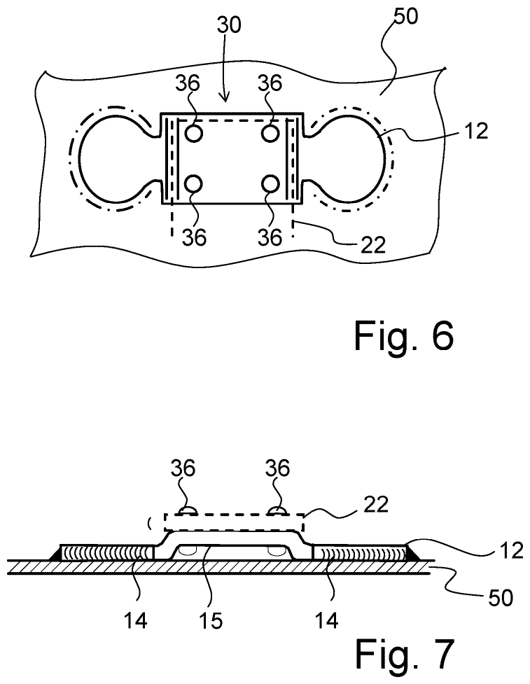

In the case of a further holding device 10 shown in FIGS. 6 and 7, the joining connection 30 is designed as a rivet connection with at least one rivet 36 instead of as a welded joint. In particular, a plurality of rivets 36 can be provided here which pass through the base portion 15 and/or can be arranged at corners of the base portion 15 (see FIG. 6). If the predetermined breaking point breaks, the at least one rivet 36 is therefore destroyed. Furthermore, the outer circumferential weld seam at the first connecting portions 14 is longer than in the variant from FIG. 1. The first fastening element 12 comprises notches at the transition between the first connecting portion 14 and the base portion 15. That is to say, the first connecting portions 14 are each tapered at a transition to the base portion 15. The combination of weld seam and the notches (so-called constriction) makes it possible to shift the stress peaks away from the end of the weld seam. Furthermore, the holding device 10 from FIGS. 6 and 7 comprises all of the features of the holding device 10 from FIG. 1. The operating medium container arrangement 100 from FIGS. 6 and 7 correspondingly comprises all of the features of the operating medium container arrangement 100 from FIG. 1.

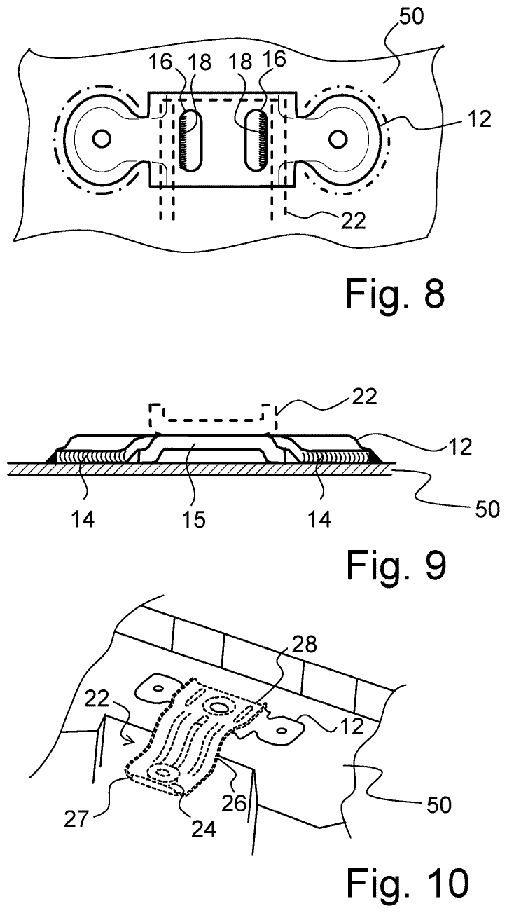

A further holding device 10 which is illustrated in FIGS. 8 to 10 differs from the holding device from FIG. 6 in that the second fastening element analogously to the variant from FIG. 4 comprises holes 16 in the form of slots/elongated holes. A main direction of extent of the holes 16 runs transversely to the main direction of extent of the first fastening element 12. One-sided slot welds are provided in the holes 16, i.e., weld seams of the joining connection 30 each extend only along part of the circumference of the respective hole 16. Furthermore, the first connecting portions 14 have elevations which, at their ends facing the base portion 15, can run flush with the base portion 15. At the first connecting portions 14, in each case drainage holes are provided centrally, and bumps are provided radially outward from the drainage holes. The drainage holes can be used to reduce/avoid permanent moisture and corrosion. Furthermore, the holding device 10 from FIGS. 8 to 10 comprises all of the features of the holding device 10 from FIG. 6. The operating medium container arrangement 100 from FIGS. 8 to 10 correspondingly comprises all of the features of the operating medium container arrangement 100 from FIG. 6.

A motor vehicle undertray assembly 200 illustrated in FIG. 11 comprises the operating medium container arrangement 100 according to one of FIGS. 1 to 10 and the motor vehicle component 102, which is a body component, in particular an undertray body component, of the motor vehicle 220. The operating medium container 50 is fixedly connected to the motor vehicle component 102 by the holding device 10. The second connecting portion 24 is screwed to the motor vehicle component 102. An electrical energy store 60 of the motor vehicle undertray assembly 200 projects with its rear end in the fitted position on the motor vehicle 220 (see FIG. 12) into an underside depression of the operating medium container 50. In the region of this depression, the operating medium container 50 rests on the upwardly facing supporting surface of the first fastening element. The holding device 10 is screwed from below onto the motor vehicle component 102. The rear end of the electrical energy store 60 is located below the holding device 10. In order to ensure that the operating medium container 50 remains undamaged as far as possible in the event of a crash, the joining connection 30 is preferably weaker than the second connection between the motor vehicle component 102 and the holding device 10.

In a method 300, illustrated in simplified form in FIG. 13, for mounting the motor vehicle undertray assembly 200, the operating medium container arrangement 100 is provided in a first step 302. This step 302 can comprise first of all producing the holding device 10, with the joining connection 30 being formed, and subsequently joining the holding device 10 non-releasably (without being destroyed) and fixedly to the operating medium container 50, with the first connection being formed. After this step 302, the operating medium container arrangement 100 can be mounted on the motor vehicle component 102 in a step 304. This step 304 can comprise connecting the operating medium container arrangement 100 to the motor vehicle component 102, preferably so as to be releasable without being destroyed, in particular with a force fit, by the second connecting portion 24. As a result, the motor vehicle undertray assembly 200 is produced with the predetermined breaking point in the holder of the operating medium container 50. The connection which is releasable without being destroyed in turn affords advantages for servicing.

For reasons of readability, in this disclosure, the expression “at least one” has sometimes been omitted for the sake of simplicity. If a feature of the technology disclosed here is described in the singular or with an indefinite article, the plural thereof is also intended to be disclosed at the same time. “At least one” indicates one or more. In this disclosure, at least in certain sections or at least partially means in certain sections/partially or completely.

The foregoing description of the present invention serves only for illustrative purposes and not for the purpose of restricting the invention. Various changes and modifications are possible in the context of the invention without departing from the scope of the invention and the equivalents thereof.

1.-15. (canceled)

16. A holding device for fastening an operating medium container to a motor vehicle component, the holding device comprising:
a first fastening element with a first connecting portion for connecting the first fastening element to the operating medium container;
a second fastening element with a second connecting portion for connecting the second fastening element to the motor vehicle component; and
a joining connection joining the first fastening element to the second fastening element, wherein the joining connection is releasable only upon being destroyed, the joining connection comprising a predetermined breaking point.

17. The holding device according to claim 16,
wherein the predetermined breaking point is configured to break upon a predetermined relative movement between the first connecting portion and the second connecting portion, whereby the first fastening element is detached from the second fastening element.

18. The holding device according to claim 16,
wherein the joining connection comprises a material bond.

19. The holding device according to claim 16,
wherein the joining connection comprises a welded joint with at least one spot weld and/or with at least one weld seam.

20. The holding device according to claim 16,
wherein the joining connection is at least partially arranged on an inner circumferential surface of a hole formed in the second fastening element.

21. The holding device according to claim 16,
wherein the joining connection comprises a rivet connection with at least one rivet.

22. The holding device according to claim 16,
wherein a plurality of first connecting portions are provided which each extend away from a base portion of the first fastening element,
wherein the joining connection is formed on the base portion.

23. The holding device according to claim 22,
wherein each of the first connecting portions is tapered at a transition to the base portion.

24. The holding device according to claim 16,
wherein the second fastening element has an angled profile with a central portion and limbs protruding in different directions from the central portion at mutually opposite ends of the central portion,
wherein the joining connection and the second connecting portion are provided on different limbs.

25. An operating medium container arrangement for a motor vehicle, the operating medium container arrangement comprising:
an operating medium container; and
the holding device according to claim 16,
the joining connection being weaker than a first connection between the operating medium container and the holding device.

26. The operating medium container arrangement according to claim 25,
wherein the holding device is welded to the operating medium container at the first connecting portion.

27. The operating medium container arrangement according to claim 25,
wherein the first connecting portion is connected to the operating medium container by at least one plug weld.

28. A motor vehicle undertray assembly comprising:
the operating medium container arrangement according to claim 25; and
a motor vehicle component,
the operating medium container being fixedly connected to the motor vehicle component by the holding device.

29. The motor vehicle undertray assembly according to claim 28,
wherein the joining connection is weaker than a second connection between the motor vehicle component and the holding device.

30. The motor vehicle undertray assembly according to claim 28,
further comprising an electrical energy store, the holding device being arranged between the operating medium container and the energy store.

31. A motor vehicle including the holding device according to claim 16.

32. A motor vehicle including the operating medium container arrangement according to claim 25.

33. A motor vehicle including the motor vehicle undertray assembly according to claim 28.

34. A method for mounting a motor vehicle undertray assembly, the method comprising, comprising:
providing an operating medium container arrangement according to claim 25;
mounting the operating medium container arrangement on a motor vehicle component, the operating medium container arrangement being connected to the motor vehicle component by the second connecting portion.
